(19) United States
(12) Patent Application Publication
(10) Pub. No.: US 2013/0124274 A1
(43) Pub. Date: May 16, 2013

(54) Advertising Point-of-Sale Checkout

(71) Applicant: Demetrios Tavlarides, Washington, DC (US)

(72) Inventor: Demetrios Tavlarides, Washington, DC (US)

(21) Appl. No.: 13/468,590

(22) Filed: May 10, 2012

Related U.S. Application Data
(60) Provisional application No. 61/457,678, filed on May 10, 2011.

(51) Int. Cl. G06Q 30/02

(52) U.S. Cl. CPC G06Q 30/0241
USPC 705/14.4

(57) ABSTRACT

A brand-specific announcement is audibly output by the point-of-sale terminal upon identification of each product as it is scanned. The brand-specific announcement. In this way, the first Coke product might announce “Coca-cola”, the second product may announce “The real thing.” In a networked application such as in a large, multiple-register checkout of a supermarket, the rotating slogans for any given product may be system wide such that the first time any of the multiple registers scans a given product, that register announces the first slogan in its defined series. The next register to scan the same product might announce the second slogan in the defined series, etc. In this way, e.g., register #3 might announce “Coca-cola”, then soon after register #6 might announce “The real thing.” A trademarked type sound may be announced instead of a slogan.

### BACKGROUND OF THE INVENTION

1. Field of the Invention

This invention relates generally to point-of-sale terminals. More particularly, it relates to supermarket and food store checkouts.

2. Background of the Related Art

Checkout registers are a ubiquitous part of everyday life, and more and more frequently checkout registers are setup to support self-checkout by a retail customer themself.

The present form of cash registers or scanners, scans and determines a list of purchased products or services, a cost of each of those products or services, and ultimately lists the purchased product or service as identified textually within an allotted character string (e.g., within 40 characters). The point-of-sale terminals typically beep upon identification of each product as it is scanned for purchase, and some audibly recite the cost.

### SUMMARY OF THE INVENTION

In accordance with the principles of the present invention, a method of providing advertising at a point-of-sale terminal comprises scanning a unique code on an item being purchased at a point-of-sale terminal. Brand-specific information related to the item being purchased is audibly output.

### BRIEF DESCRIPTION OF THE DRAWINGS

Features and advantages of the present invention will become apparent to those skilled in the art from the following description with reference to the drawings, in which:

FIG. 1 shows an exemplary point-of-sale terminal including an audible slogan system for audibly announcing brand-specific advertising for each product as it is purchased, in accordance with the principles of the present invention.

FIG. 2 shows an exemplary brand-specific advertising database storing one or more brand-specific advertising slogans for each product available for sale at a given retail establishment, in accordance with the principles of the present invention.

### DETAILED DESCRIPTION OF ILLUSTRATIVE EMBODIMENTS

The present invention recognizes an opportunity for subtle advertising directed at the purchaser and adjacent persons. In accordance with the principles of the present invention, a brand-specific announcement is audibly output by the point-of-sale terminal upon identification of each product as it is scanned.

The brand-specific announcement may be generically defined, e.g., “Coca-cola”.

Additionally, such an audible brand-specific announcement made at the purchase of each item provides an opportunity for the retailer to raise additional income by selling customization of an annoucement given for their product. For example, contractual terms may be agreed upon between the retailer of the products and services and the supplier of the products or services to instead of saying, e.g., “Coca-cola”, to announce a slogan such as “Its the real thing”.

Moreover, a rotating series of agreed-upon slogans for any given product may be announced for each time the same product passes through a point-of-sale terminal. In this way, the first Coke product might announce “Coca-cola”, the second product may announce “The real thing.”

In a networked application such as in a large, multiple-register checkout of a supermarket, the rotating slogans for any given product may be system wide such that the first time any of the multiple registers scans a given product, that register announces the first slogan in its defined series. The next register to scan the same product might announce the second slogan in the defined series, etc. In this way, e.g., register #3 might announce “Coca-cola”, then soon after register #6 might announce “The real thing.”

A trademarked type sound may be announced instead of a slogan, depending upon the desires of the retailer (and any agreement they might have with the relevant wholesalers.

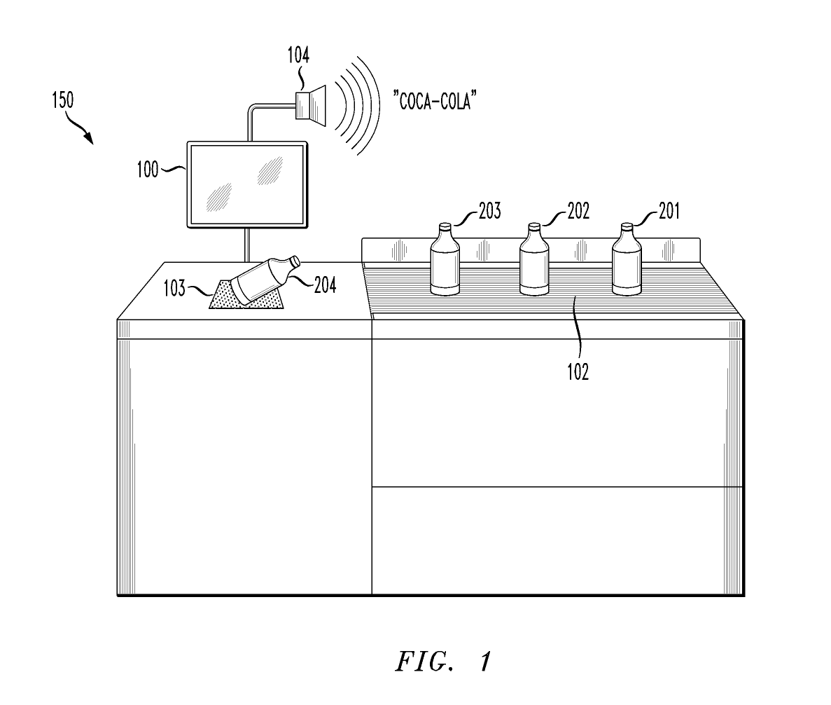

FIG. 1 shows an exemplary point-of-sale terminal including an audible slogan system for audibly announcing brand-specific advertising for each product as it is purchased, in accordance with the principles of the present invention. In particular, as shown in FIG. 1, a point-of-sale terminal 150 adapted for use at a supermarket includes a barcode or similar infrared or laser scanner 103, an audible announcement unit 100, and speaker 104. The given example shows a conveyer belt 102 for conveying purchased products 201, 202, 203 as they are scanned.

In the given exemplary system shown in FIG. 1, when product 201 is purchased, the system, instead of announcing scanned recognition of the product 201 with a beep, or its price, the inventive system accesses a database associated with the audible announcement unit 100 to identify the defined or next brand-based slogan to be output, then outputs it audibly through the point-of-sale terminals speaker 104. The slogans may be stored in the database as text and converted to voice as needed, or more preferably are stored as compressed audio files and output directly without conversion (but with decompression if necessary). In the given example of FIG. 1, the products 201-204 may have been announced to the customer in an audible stream that sounded like “Coca-cola . . . The real thing . . . Better than Pepsi . . . Coca-cola”.

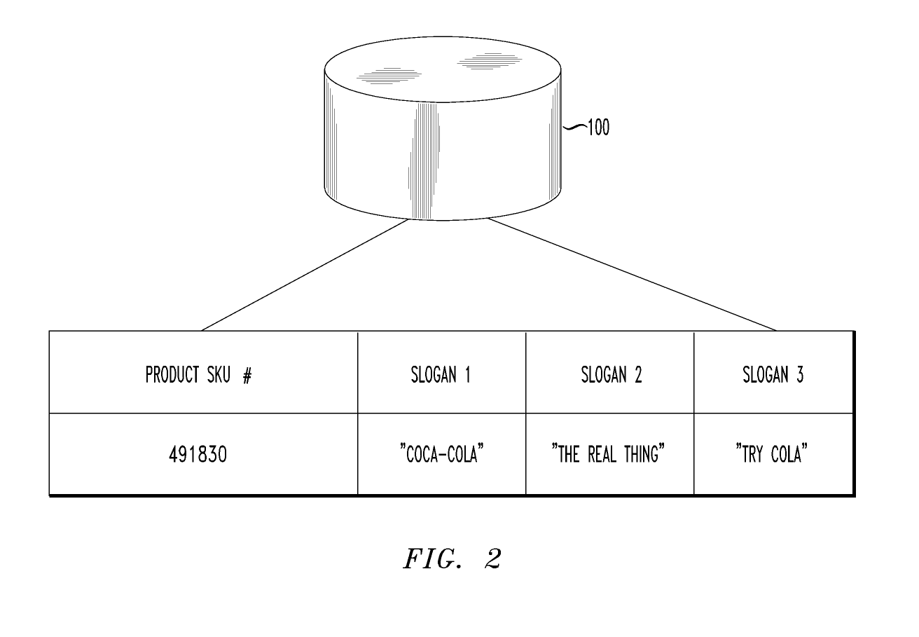

FIG. 2 shows an exemplary brand-specific advertising database storing one or more brand-specific advertising slogans for each product available for sale at a given retail establishment, in accordance with the principles of the present invention.

In particular, as shown in FIG. 2, the audible announcement unit 100 includes a database associating each product sold by the retailer to one or more slogans.

The present invention provides a point-of-sale system that adds greatly to the enjoyment of life in general as instead of hearing a robotic “beep”, or even a routing price of a product being purchased, the announcements may provide a vehicle for commercial advertising for the wholesalers, additional revenue source for retailers, and entertainment and enjoyment for the customers as they hear a chorus of orchestrated slogans from multiple registers within earshot.

The loudness of each announced brand-based slogan, trademarked sound, etc., can be adjusted to a desirable level by the retailer, either to define an audible range for persons to hear the slogan, or even as an additional revenue source by charging wholesalers more for playing their slogan louder. The more a wholesaler pays, the louder their slogan(s) may be announced.

In accordance with another aspect of the invention, it may instead by used to simply create an orchestrated musical arrangement from among a plurality of point-of-sale terminals. For instance, in a busy checkout environment such as in many supermarkets, each time any of the point-of-sale terminals identify a product being purchased, the next note of a given musical piece may be played. The faster products are purchased, the faster the musical piece gets played, albeit by any or all of the multiple point-of-sale terminals.

With the present invention, a new process of advertising is now possible when the name of the product is verbally announced out loud to at least the customer making the purchase, and depending upon the particular application as well as to others within a given audible range of the customer making the purchase causing that verbal announcement, e.g., “Coca-cola”. Thus, persons in a store will hear, instead of “beep . . . beep beep . . . beep . . . beep”, they will not hear the beep but instead of the beep hear, e.g., “Coca-cola . . . Coca-cola Coca-cola . . . Coca-cola . . . Coca-Cola”. Or even “Coca-cola . . . The real thing Try Coke . . . better than Pepsi . . . Coca-cola”.

The present invention enables supermarket retailers and manufacturers to develop a new market and a new type of advertising agreement among themselves. Increased revenue to the retailer will provide additional opportunity to reduce the cost of the products to the customers, and providing more ability to undercut competition, thus having benefits to all. Plus it eliminates the boring “beep beep beep” sound pervading the checkout area of todays supermarkets.

The present invention does not require all branded products within a retail establishment to have established a slogan to be used for their product. A generic audible announcement may be made when those products are purchased, or even no announcement at all instead using the otherwise conventional “beep” for those products, emphasizing even more those products that do have advertising agreements in place with the retailer. For example, the impact to the advertiser may be even greater in a situation such as: “beep. . . beep beep . . . Coca-cola . . . beep”.

The present invention has most applicability to self-checkout equipment for use by a supermarket, but is equally applicable to tended checkout equipment in that or any other retail outlet.

While the invention has been described with reference to the exemplary embodiments thereof, those skilled in the art will be able to make various modifications to the described embodiments of the invention without departing from the true spirit and scope of the invention.

What is claimed is:

1. A method of providing advertising at a point-of-sale terminal, comprising:
scanning a unique code on an item being purchased at a point-of-sale terminal; and
audibly outputting a brand-specific announcement related to said item being purchased.

2. The method of providing advertising at a point-of-sale terminal according to claim 1, wherein:
said brand-specific announcement is coordinated with an announcement of a same brand being purchased at a second point-of-sale terminal.

3. The method of providing advertising at a point-of-sale terminal according to claim 1, wherein said unique code comprises:
a bar code.

4. The method of providing advertising at a point-of-sale terminal according to claim 1, wherein said unique code comprises:
a Quick Response (QR) code.

5. The method of providing advertising at a point-of-sale terminal according to claim 1, wherein:
said audibly output brand-specific announcement is audibly output sufficient to be heard at a plurality of point-of-sale terminals.

6. The method of providing advertising at a point-of-sale terminal according to claim 1, wherein:
said brand-specific announcement is rotated among a plurality of possible brand-related announcements for any given product each time the same product type passes through said point-of-sale terminal.
